(19) United States
(12) Patent Application Publication
(10) Pub. No.: US 2012/0017247 A1
(43) Pub. Date: Jan. 19, 2012

(54) CONTENT BROADCASTING

(75) Inventors: Kevin Hodson, Hertfordshire (GB); Donald Lester, Hertfordshire (GB); Ian Leslie Cullen, Wales (GB)

(73) Assignees: ECONET WIRELESS IP HOLDINGS LIMITED, Port Louis (MU); ASTRIUM LIMITED, Stevenage Hertfordshire (GB)

(21) Appl. No.: 13/139,244

(22) PCT Filed: Dec. 10, 2009
(86) PCT No.: PCT/EP2009/066881

§ 371 Date: Sep. 27, 2011

(30) Foreign Application Priority Data
Dec. 10, 2008 (GB) 0822492.5

(51) Int. Cl. H04N 7/20

(52) U.S. Cl. 725/67

(57) ABSTRACT

The invention provides a content broadcasting system comprising a communications satellite and a satellite control arrangement for controlling the communications satellite to transmit a satellite broadcast signal. The satellite control arrangement is arranged to control the satellite to transmit the satellite broadcast signal to a first geographical area during a first time interval and to transmit the satellite broadcast signal to a second geographical area during a second time interval. The broadcast signal is not transmitted to the first geographical area during at least the second time interval and the broadcast signal is not transmitted to the second geographical area during at least the first time interval. This enables broadcast content to be provided to a large geographical area, while increasing the radio frequency spectrum efficiency of the system and minimising the continuous power consumption of the satellite required for the broadcast.

The invention relates to content broadcasting, particularly but not exclusively to a system and method for broadcasting content over a continental area by satellite.

Television and other such content has traditionally been broadcast from terrestrial high-power transmitters operating in the VHF and UHF bands. Such transmitters can usually reach a significant proportion of the population of a country, for instance between 80 to 90%. Most of the remainder of the population are served by a network of low-power relay transmitters, perhaps leaving 1% or so without a signal of sufficient strength, although this could be closer to 50% in some countries such as African countries. In a small, developed country such as the UK, a network of over 1000 terrestrial transmitters is required.

Analogue television is being replaced by digital. Some countries have completed the transition, many are in the process of upgrading the terrestrial network and others are in the planning stage. The upgrade to digital can be an expensive undertaking, especially so if the complete broadcasting infrastructure within the country needs to be modified and a large geographical area is to be covered.

Some countries are opting for a hybrid solution where only the transmitters serving the main population centres are upgraded and the population that was previously served by relay transmitters are expected to receive signals from a satellite, for instance in a radio frequency band such as the allocated 10.7 to 12.75 GHz satellite communications band in the UK. However, although such satellite television broadcasts are a popular alternative to digital terrestrial television (DTT), reception of the broadcast signals requires specific, small, high gain parabolic receiving aerials, for instance having a forward gain of about 30 dBi, which are relatively expensive to manufacture and require accurate alignment with incoming signals. Furthermore, due to power constraints, current satellites can only broadcast a television-type service over relatively small regions, making satellite broadcasts unsuitable for large geographical areas, for instance those spanning several countries such as North America or sub-Saharan Africa.

The present invention aims to provide an improved broadcasting system and method addressing the drawbacks inherent in the art.

According to the invention, there is provided a content broadcasting system comprising a communications satellite and a satellite control arrangement for controlling the communications satellite to transmit a satellite broadcast signal, wherein the satellite control arrangement is arranged to control the satellite according to a predetermined broadcast schedule so as to transmit said satellite broadcast signal to a first geographical area during a plurality of first time intervals such that it can be received by receiving devices in the first geographical area during the first time intervals and transmit said satellite broadcast signal to a second geographical area during a plurality of second time intervals such that it can be received by receiving devices in the second geographical area during the second time intervals, wherein said broadcast signal is not transmitted to the first geographical area during at least said second time intervals and said broadcast signal is not transmitted to the second geographical area during at least said first time intervals.

Accordingly, the invention enables broadcast content to be provided to a large geographical area, while minimising the continuous power consumption of the satellite required for the broadcast by broadcasting a signal over different geographical regions at different times. Satellites provide a green alternative to terrestrial transmission networks and save millions of tons of CO₂ over their lifetime.

The satellite control arrangement can be arranged to control the satellite to transmit the satellite broadcast signal at the same frequency during the pluralities of first and second time intervals. It is usual for satellites employing multiple spot beams to operate such beams on different frequencies to avoid mutual interference. The present invention, by broadcasting to only one of first and second geographical areas at any particular time, enables frequency re-use for the broadcasts in these areas.

The satellite broadcast signal can be used to broadcast first content during said first time intervals and to broadcast second content, different from said first content, during said second time intervals.

The content broadcasting system can further comprise a first receiving device located within the first geographical area and a second receiving device located within the second geographical area, wherein, the first receiving device is arranged to receive the satellite broadcast signal during the first time intervals and the second receiving device is arranged to receive the satellite broadcast signal during the second time intervals, wherein the first receiving device is arranged to record content associated with the satellite broadcast signal transmitted during the first time intervals and wherein the second receiving device is arranged to record content associated with the satellite broadcast signal transmitted during the second time intervals.

The first receiving device can comprise a connector for connecting to a removable storage medium and be arranged to record content associated with the satellite broadcast signal on a removable storage medium coupled to the connector.

The first receiving device can comprise a processor configuration arranged to control the first receiving device to enter a power-saving mode at times other than the first time intervals.

The processor configuration can be arranged to detect the transmission of the broadcast signal to the at least one first geographical area and to control the first receiving device to stop using the power saving mode in response to the result of the detection.

The first receiving device can further comprise a clock, wherein the satellite broadcast signal comprises information indicating at least one of said first time intervals, and the processor configuration can be arranged to control the first receiving device to enter a sleep mode at times other than the at least one of the first time intervals, in accordance with the information and an output from the clock.

The satellite control arrangement can be further arranged to control the satellite to direct said satellite broadcast signal to one or more further geographical areas during one or more respective pluralities of further time intervals.

The pluralities of first, second and one or more further time intervals can comprise a sequence of time intervals, and wherein the sequence is repeated.

The satellite broadcast signal can be used to broadcast an audio and/or video signal at a data rate slower or faster than the data rate of the audio and/or video signal when reproduced.

The satellite broadcast signal can be transmitted at frequencies between and including 600 MHz to 40 GHz.

The satellite broadcast signal can be transmitted at frequencies in the UHF or SHF frequency range.

The satellite broadcast signal can be transmitted at frequencies between and including 600 MHz to 2.5 GHz.

The satellite broadcast signal can be receivable using a Yagi-Uda antenna.

The satellite control arrangement can be arranged to control the satellite so as to transmit said satellite broadcast signal to a plurality of first geographical areas, including the first geographical area, during the first time intervals such that it can be received by receiving devices any of the plurality of first geographical areas during the first time intervals and transmit said satellite broadcast signal to a plurality of second geographical areas, including the second geographical area, during the second time intervals such that it can be received by receiving devices in any of the plurality of second geographical areas during the second time intervals.

The broadcast signal can be used to provide content to a first one of the plurality of first geographical areas which is different from content provided to a second one of the plurality of first geographical areas.

According to the invention, there is also provided a method of broadcasting content, the method comprising transmitting a satellite broadcast signal according to a predetermined broadcast schedule, wherein the satellite broadcast signal is transmitted to a first geographical area during a plurality of first time intervals such that it can be received by receiving devices in the first geographical area during the first time intervals and to a second geographical area during a plurality of second time intervals such that it can be received by receiving devices in the second geographical area during the second time intervals, wherein said broadcast signal is not transmitted to the first geographical area during at least said second time intervals and said broadcast signal is not transmitted to the second geographical area during at least said first time intervals.

The pluralities of first and second time intervals can comprise a repeating sequence of time intervals according to the broadcast schedule.

The satellite broadcast signal can be used to broadcast an audio and/or video signal at a data rate slower or faster than the data rate of the audio and/or video signal when reproduced.

Embodiments of the invention will now be described, by way of example, with reference to the accompanying drawings, in which:

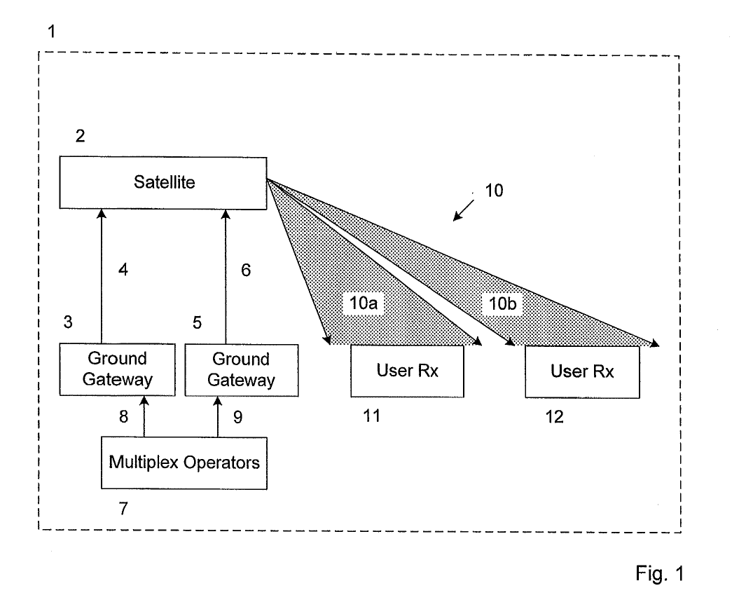

FIG. 1 is a schematic illustration of a content broadcasting system according to an embodiment of the invention;

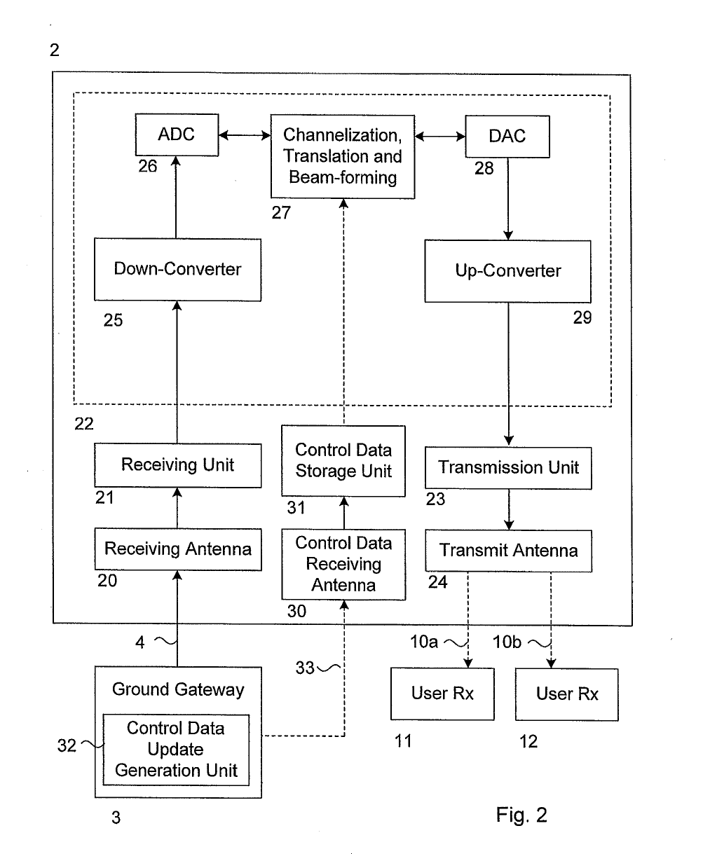

FIG. 2 is a schematic illustration of functional components of a satellite forming part of the content broadcasting system of FIG. 1;

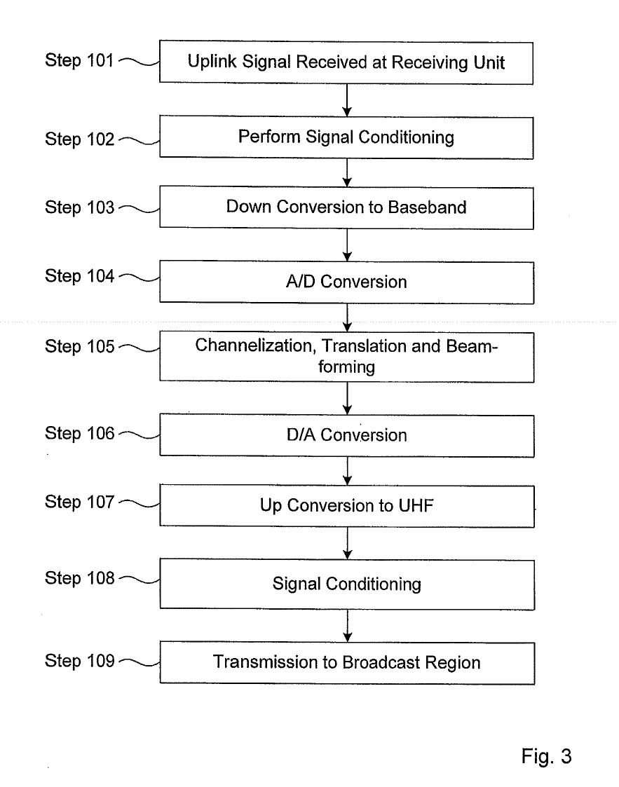

FIG. 3 is a flow diagram illustrating steps performed at the satellite of FIG. 2;

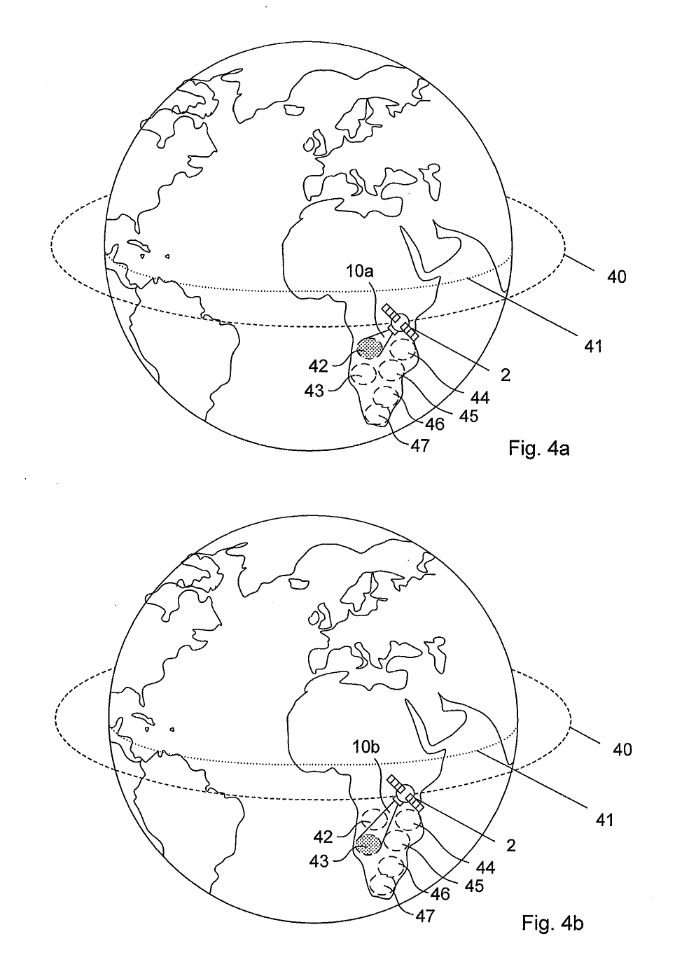

FIGS. 4a and 4b illustrate the satellite of FIG. 2 in an orbital position transmitting a broadcast signal and the associated coverage area of the transmission during different respective transmission intervals, based on a broadcast schedule according to an embodiment of the invention;

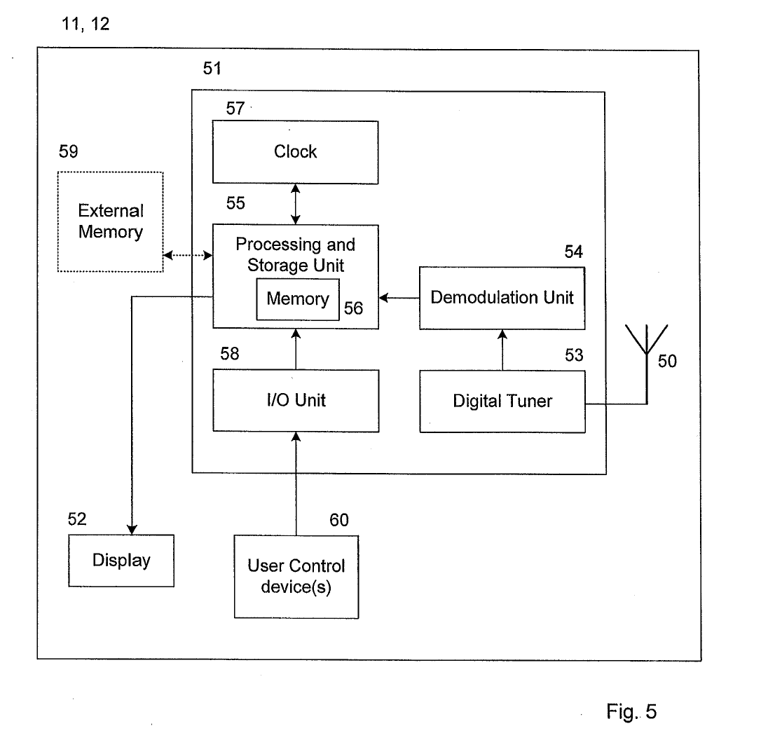

FIG. 5 is a schematic illustration of functional components of a receiver for receiving a satellite broadcast according to an embodiment of the invention; and

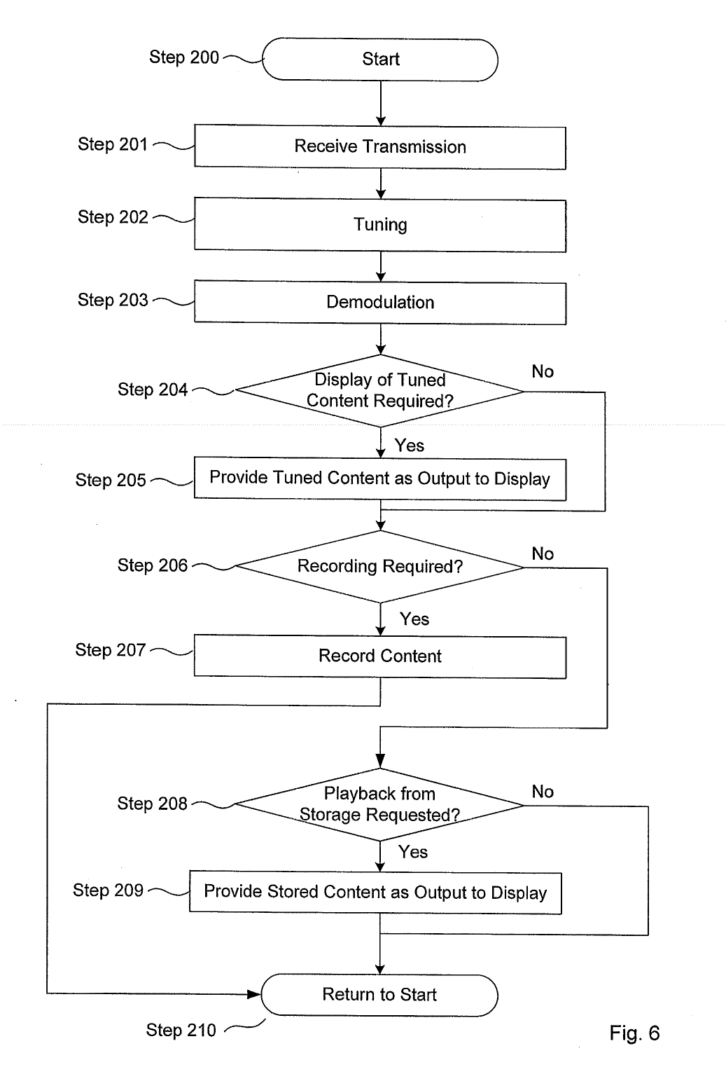

FIG. 6 is a flow diagram illustrating the steps performed at the receiver of FIG. 5 in receiving and processing broadcast content.

Referring to FIG. 1, a content broadcasting system 1 according to an embodiment of the invention comprises a communications satellite 2 arranged to receive broadcast content from a first ground gateway 3 via a first uplink channel 4, the broadcast content being content which is to be broadcast from the satellite 2. The satellite 2 is also arranged to receive broadcast content from a second ground gateway 5 via a second uplink channel 6. The first and second ground gateways 3, 5 are each arranged to the broadcast content from one or more multiplex operators 7 via respective first and second multiplex content feeds 8, 9. The satellite 2 is arranged to re-transmit the broadcast content via a downlink beam 10, the downlink beam 10 being provided, during a first time period, as a first transmission 10a to user receivers including a first user receiver 11 located in a first geographical area and, during a second time period, as a second transmission 10b to user receivers including a second user receiver 12 located in a second geographical area.

In use, the multiplex operators 7 are responsible for providing multiplex content to the ground gateways 3, 5 via the multiplex content feeds 8, 9. This includes defining the bit rates and compression format of the contributory streams of the multiplex content feeds 8, 9. The multiplex operators 7 provide synchronous digital streams as the content feeds 8, 9. In the system illustrated in FIG. 1, the content feeds 8, 9 to the ground gateways 3, 5 are provided via terrestrial optical fibre links. Other communications channels can alternatively or additionally be used, for instance terrestrial RF transmissions or business-to-business satellite links. Suitable service level agreements (SLAs) can be put in place to guarantee quality of service and the availability of the content feeds 8, 9.

The first and second ground gateways 3, 5 are located in a site diversity arrangement, separated by a distance of about 30 km to provide adequate diversity with regards to weather patterns and/or other geographically dependent factors such as fires, earthquakes, acts of terrorism etc which could potentially degrade the uplink channels 4, 6 or prevent the channels from being transmitted. The first and second ground gateways 3, 5 can alternatively be separated by a distance greater or smaller than 30 km depending on the circumstances.

The first and second ground gateways 3, 5 include coded orthogonal frequency-division multiplexing (COFDM) modulators and are each arranged to transmit a COFDM modulated signal, according to the digital video broadcasting satellite-to-handheld (DVB-SH) physical layer standard, to the communications satellite 2 at frequencies of approximately 14 GHz. Other modulation schemes, signal formats and frequencies can alternatively or additionally be used. For instance, alternative modulation can be applied to the content feeds, such as a time or code division multiplexing modulation scheme. Also, another suitable standard such as the digital video broadcasting-terrestrial (DVB-T), digital video broadcasting to handheld (DVB-H) or European Telecommunications Standards Institute (ETSI) standard for digital radio (ESDR) could be used. The uplink to the satellite 2 can also be provided at other carrier frequencies, for instance frequencies in the C Band (4 to 8 GHz) or alternative frequencies within the Ku band, such as frequencies at about 17 GHz, or frequencies in other bands such as the Ka band, for instance frequencies at about 29 GHz.

In the present example, QPSK modulation is applied to the COFDM signal, providing a useful bit rate of 8 Mbit/s, enough for 4 standard definition TV channels.

In normal use, only one of the first and second ground gateways 3, 5 transmits to the satellite 2 at any one time. In the event of a transmission failure at one of the first and second gateways 3, 5, such as a failure caused by an uplink fade resulting from adverse weather patterns or equipment failure at the transmitting gateway 3, 5, a hand-over protocol ensures that the other ground gateway 3, 5 takes over the transmission within a few milliseconds. Radiometers (not shown) located at the ground gateways 3, 5 detect and predict uplink fades enabling a timely hand-over. In the present example, the COFDM DVB-SH signal is buffered at the satellite 2 and/or at the receivers 11, 12, such that the time of arrival of the resulting broadcast at any user device is well within the COFDM guard interval. This ensures that any transmission hand-over between the first and second ground gateways 3, 5 is seamless with respect to user receiving devices.

FIG. 2 is a schematic illustration of the functional components of the satellite 2 forming part of the broadcasting system 1 of FIG. 1.

Referring to FIG. 2, the satellite 2 is illustrated in the present example as receiving the first uplink channel 4 from the first ground gateway 3. The satellite 2, in the present case a multi-beam, high-power global communications satellite, includes a receiving antenna 20 connected to a receiving unit 21. The receiving unit 21 is connected to a signal processing arrangement 22, which provides an output to a transmission unit 23 connected to a transmission antenna 24. The signal processing arrangement 22 includes a down-converter 25, an analogue to digital converter (ADC) 26, a channelization, translation and beam-forming unit 27, a digital to analogue (D/A) converter 28 and an up-converter 29.

The receiving unit 21 includes various front-end signal receiving and conditioning components, for instance a low noise amplifier (LNA). The design and implementation of such components is well known in the field. The transmission unit 23, also referred to as a transmitter, includes various components for conditioning signals for transmission via the downlink beam 10, in the present example including a multi-port amplifier (MPA) arrangement. The transmission antenna 24 is, in the present case, a high gain parabolic reflector antenna.

The satellite 2 also includes a control data receiving antenna 30 and a control data storage unit 31. The control data storage unit 31 is used to store control data for controlling the transmission of the satellite downlinks 10a, 10b according to a predetermined broadcast schedule. The control data can, for instance, comprise coefficients for use in adjusting the beam-forming operations of the channelization, translation and beam-forming unit 27. The control data storage unit 31 and channelization, translation and beam-forming unit 27, according to embodiments of the invention, provide a satellite control arrangement for controlling broadcasts made by the satellite. However, other control arrangements could be used as would be appreciated by those skilled in the art. The ground gateway 3 includes a control data update generation unit 32 which is arranged, in use, to provide control data updates via a control data transmission channel 33 and the control data receiving antenna 30 to the control data storage unit 31 where they are stored. The second and any further ground gateways 5 can also be arranged to include corresponding control data update generation units for providing updates via corresponding control data transmission channels.

The channelization, translation and beam-forming unit 27 is, in the present example, capable of processing 32 separate channels that ultimately drive 32 antenna feeds via the MPA of the transmission unit 23. This arrangement of multiple feeds has two advantages. Firstly, it enables the high power required from the payload to be distributed over a large number of amplifiers in the MPA and, secondly, it enables frequency-selective beam forming to be applied by the channelization, translation and beam-forming unit 27 by varying the complex weights for each feed.

The MPA arrangement of the transmission unit 23 includes, in the present example, 16 eight-way multiple port amplifiers (MPAs), where only two inputs and outputs on each MPA are used, thus providing the 32 output antenna feeds. The radiated power from the high gain parabolic reflector antenna 24 effectively sums in the far field of the reflector.

In the present example, a polarisation capability is provided for improved flexibility and spectrum efficiency. Using polarisation enables two different signal streams to occupy the same part of the transmit frequency spectrum. The transmit antenna 24 is configured to generate output transmissions in either or both polarisations, with the polarisation being circular (left hand or right hand) in the present example. In this case, the radiating element(s) of the transmit antenna 24 comprise a left hand or right hand helix. Alternatively, a hybrid network could drive separate radiating elements which are 90 degree phase shifted to achieve the same result. A hybrid network (polariser, not shown in Figures) can be used to select which polarisation is used for each signal. Changing the phase relationship between elements, for instance by driving different ports on the hybrid, would determine whether the output signal was left hand or right hand.

According to the invention, functionality is incorporated within the processor 22 for selecting which MPA inputs and hence output ports would be used for a particular signal, thereby permitting signals of the appropriate polarisation to be directed to the appropriate port of the hybrid network, which would be arranged between the MPA and the antenna feed elements.

In the case of linear (horizontal or vertical) polarisation, the transmit antenna can comprise horizontal and vertical polarising elements and a hybrid network (polariser, not shown in Figures) can be used to select which of the horizontal and vertical elements is driven by which signal. Alternatively, the reflecting surface of the transmit antenna can comprise a grid of rods such that only the matching polarisation would be reflected.

FIG. 3 is a flow diagram illustrating steps performed at the satellite 2 of FIG. 2 in broadcasting content.

Referring to FIG. 3, in an initial step, the first uplink signal 4 is received at the receiving unit 21 of the satellite 2, via the receiving antenna 20 (step 101) and signal conditioning is performed on the received signal (step 102) such as low noise amplification using the low noise amplifier of the receiving unit 21. The signal multiplexes received at the receiving unit 21 are provided to the signal processing unit 22 where they are down-converted by the down-converter 25 from the uplink frequencies, in the present example at approximately 14 GHz in the Ku band, to baseband frequencies (step 103). In the present example, the DVB-SH signal to be broadcast by the satellite 2 is arranged, on transmission, to span channels 52 to 68 in the UHF terrestrial broadcasting plan, corresponding to 718 to 854 MHz, with each multiplex channel having a centre on an 8 MHz grid. In order to allow for the direct sampling of the ensemble of multiplex signals with a sampling frequency within the bounds of available space-qualified analogue to digital converters, the signals are down-converted by the down-converter 25 such that the centre frequency of the lowest multiplex channel is at 140 MHz and that of the highest channel is at 268 MHz.

The analogue to digital converter 26 samples and converts the down-converted DVB-SH multiplex signals from the analogue to the digital domain (step 104). The spectrum is preferably sampled at at least six times the width of the required 136 MHz bandwidth, such that there is sufficient processed spectrum to accommodate the wanted band plus the bandwidth likely to be occupied by any 3^{rd}-order intermodulation products generated by non-linear amplification. Conveniently, this creates the possibility for power amplifier pre-compensation on a sample-by-sample basis.

The converted digital signal is processed by the channelization, translation and beam-forming unit 27 (step 105). In particular, each of the 32 digital processing channels in the channelization, translation and beam-forming unit 27 modifies the digital samples in the time domain according to the known characteristic of each MPA in the transmission unit 23 via a look-up table. Each sample is modified in amplitude according to its drive level.

The channelization, translation and beam-forming unit 27 then converts the sample stream into the frequency domain where beam-forming weights can be applied according to feed number and required UHF channel number. The multiplex signal weightings are adjusted in accordance with control data stored in the control data storage unit 31 to provide, in the present example, either the downlink transmission 10a to the first geographical area or the downlink transmission 10b to the second geographical location, via the transmission antenna 24, depending on the particular time interval in which the broadcast is to be made. The control data is, in the present example, pre-stored prior to launch of the satellite 2, but can additionally be updated during operation of the satellite 2 when this may be required, for instance via the control data update generation unit 32 of the first ground gateway 3 and the control data transmission channel 33. Updates may, for instance, be required in response to changes in the broadcast schedule which determines the time intervals during which the broadcast signal 10a, 10b will be provided to each geographical area.

A stream of real samples is applied to the digital to analogue converter 28, where the signal is converted into an analogue signal (step 106) before being up-converted to the correct UHF channel frequencies (step S107) by the up-converter 29. In the present example, as mentioned above, the signal is up-converted to UHF Band V, namely spanning channels 52 to 68 in the UHF terrestrial broadcasting plan, that is, 718 to 854 MHz, with each multiplex having a centre frequency on an 8 MHz grid. Each downlink channel frequency, in the present example, is determined by the corresponding uplink frequency.

After up-conversion to the UHF channel frequencies, the resulting multiplex signals are conditioned for transmission (step 108). In particular, in the present example, each multiplex signal feeds one of the inputs of the 16 eight-way MPAs in the transmission unit 23, such that two feeds are provided to each MPA. In alternative embodiments, other MPA configurations or alternative power amplifiers can be used, as would be appreciated by those skilled in the art.

Current technology generally limits the amount of power continuously available on a satellite such as the global communications satellite 2 of FIG. 1 to less than about 20 kW. This power is several orders of magnitude lower than that used by a terrestrial network for broadcasting content such as television, but the geometry of the satellite's position relative to the Earth and the use of high gain parabolic reflector antennas at the satellite 2 for broadcast transmissions means that, unlike a group of terrestrial transmitters, a satellite can provide a more uniform signal strength over a particular geographical area. However, even so, a single satellite would have insufficient power to provide a continuous service over a large continental area. For instance, to achieve a broadcast service, such as a digital television service, over an area the size of North America or sub-Saharan Africa, current techniques are likely to result in a satellite requiring a continuous power output of about 100 kW, which is impractical with current technology.

The single satellite 2 according to the invention, having relatively low power when compared to terrestrial transmitter networks, provides a broadcast service over a continental area by ‘hopping’ the downlink broadcast beam 10 such that individual geographical areas, such as countries, are illuminated for only part of the time. This is achieved by controlling the satellite 2, via broadcast control data, to transmit a satellite broadcast signal which is time divided between multiple geographical areas based on a predetermined broadcast schedule. The broadcast signal provides a single frequency network (SFN) over each respective geographical area while that area is illuminated.

FIGS. 4a and 4b illustrate the satellite 2 in orbit providing a footprint over regions of sub-Saharan Africa, based on a predetermined broadcast schedule according to an embodiment of the invention.

Referring to FIG. 4a, the satellite 2 is in a geostationary orbit following a trajectory 40 directly above the Earth's equator 41. The satellite 2 is arranged to have an orbital period matching the Earth's sidereal rotation period, and to orbit at an altitude of approximately 35,786 km above the mean sea level. The satellite 2 is arranged to provide the downlink channel 10 as a first transmission 10a during a first time period. In this example, the first transmission 10a provides coverage to a first geographical area 42, also referred to as a first cell, having a diameter of approximately 400 miles.

FIG. 4b illustrates the satellite 2 in the same geostationary orbit as that of FIG. 4a, except this time the satellite 2 is arranged to provide the downlink channel 10 as a second transmission 10b during a second time period. In this example, the second transmission 10b provides coverage to a second geographical area 43, also referred to as a second cell, having a diameter of approximately 400 miles.

The satellite 2, in the embodiment illustrated in FIGS. 4a and 4b, is also arranged to broadcast the downlink channel 10 via third to sixth transmissions (not shown) having coverage in respective further third to sixth geographical areas 44, 45, 46, 47, also referred to as third to sixth cells, during respective third, fourth, fifth and sixth time periods. The fifth and sixth geographical areas 46, 47 are directly adjacent.

The content broadcasting system 1 is arranged to broadcast content sequentially to each of the first to sixth geographical areas 42 to 47 over a 24 hour period, according to the predetermined broadcast schedule. The daily ‘dwell time’ of the beam over each geographical area 42 to 47 is pre-determined by the number of hours of content, such as television programming, that are required to be delivered to a user receiver in that area during that time. For instance, in one example, the content broadcasting system 1 is arranged to broadcast each transmission to each of the respective first to sixth geographical areas 42 to 47 with a dwell time of 4 hours for each transmission, thus transmitting to each area 42 to 47 for an equal time period over the 24 hours, the satellite 2 for instance transmitting to the first geographical area between midnight and 4 am, to the second geographical area between 4 am and 8 am etc.

Advantageously, the non-continuous illumination of adjacent geographical areas, such as the fifth and sixth geographical areas 46, 47, avoids any mutual interference issues that would otherwise occur during the simultaneous illumination of these cells when operating at the same transmission frequencies. Non-continuous and therefore non-simultaneous illumination of geographical areas therefore achieves a more efficient use of the RF spectrum than conventional satellite or terrestrial transmission means. This is of particular importance in the lower frequency bands used for conventional broadcast services, where the available spectrum is scarce.

The downlink beam 10 is designed to be capable of being received by a nominal 12 dBi Yagi-Uda antenna and digital terrestrial television (DTT) receiver with a noise figure of 7 dB. Such antennas are readily available and relatively cheap to manufacture. An allowance in the noise figure is made for the down-lead cable between the antenna and the set top box, namely 3 dB, a further 3 dB for aerial mis-pointing and 1 dB for the uplink channel 4, 6. The antenna, for instance, has a half-gain beam width of about 30 degrees or more, although half gain beam widths of 15 degrees or lower can also be used, though requiring more accurate alignment.

FIG. 5 schematically illustrates components of the first and second user receivers 11, 12 of the system of FIG. 1.

The receivers 11, 12 each include a receive antenna 50, in the present case a 12 dBi Yagi-Uda antenna having a half-gain beam width of 30 degrees, connected to a set top box 51 which is in turn connected to a display 52. The set top box 51 is arranged to receive and process the DVB-SH broadcast and includes a digital tuner 53, a demodulation unit 54, a processing and storage unit 55 including memory 56, a clock 57 and an input/output unit 58. The memory 56, also referred to as internal memory, is flash memory, although other forms of non-volatile memory can alternatively be used.

The digital tuner 53 is connected to the signal output of the antenna 50 and is, in turn, connected to the demodulation unit 54. The demodulation unit 54 is connected to the processing and storage unit 55, which is connected to both the clock 57 and the I/O unit 58.

In some embodiments of the invention, an external memory 59, in the present example a USB flash-memory device, can be coupled to a connector on the set-top box 51, in the present case a USB port. In this way, the external memory 59 can be connected to the processing and storage unit 55. Other forms of removable non-volatile memory can alternatively or additionally be used.

The I/O unit 58 is connected to one or more user control devices 60, for instance user selection buttons provided on the outside of the set-top box 51 and/or a remote control device. Such devices can, for instance, be used to control functions of the set top box 51 such as switching the set top box 51 between an ‘on’ state and a ‘standby mode’ and controlling tuning and playback of content.

FIG. 6 is a flow diagram illustrating the steps performed at the receiver 11, 12 illustrated in FIG. 5 in receiving and processing broadcast content.

In use, the process starts (step 200) and a satellite transmission, this being the first transmission 10a for the first receiver 11 or the second transmission 10b for the second receiver 12, is received via the downlink channel at the antenna 50 during the transmission period for that geographical area (step 201). The signal is provided to the digital tuner 53, where tuning to a particular broadcast channel is performed (step 202). Where the broadcast includes only a single programme channel, this channel is tuned into. Alternatively, where multiple programme channels are broadcast, a channel selected by the user, for instance via the one or more control devices 60, is tuned into. The tuned signal is then demodulated by the demodulation unit 54 (step 203).

The processing and storage unit 55, also referred to as a storage and playout unit, determines whether or not the display of the tuned content is required (step 204) and, if so, the tuned video signal is output to the display 52 to be viewed by a user (step 205). In the present embodiment, the default state of the set top box 51 is that, when turned on, tuned content is provided to the display 52.

Whether or not tuned content is to be displayed, the processing and storage unit 55 determines whether recording of the tuned content is required (step 206). The user can select to record tuned content in the internal memory 56 via a command entered at the one or more user control devices 60. In the present example, such commands can be entered while content is being tuned into and at the time that recording is to take place, or in advance, whereby an indication of the required recording start time, duration and, if relevant, programme channel, is entered by a user and stored in the internal memory 56 and accessed by the processing and storage unit 55 to determine whether recording is required, based on a current time determined by the clock 57. If recording is required, tuned content is provided by the digital tuner 53 to the internal memory 56, via the demodulation unit 54, to be recorded (step 207).

If recording is not required, the processing and storage unit 55 determines whether playback of content from the internal memory 56 is required, for instance whether this has been requested via a command entered by the user via the one or more user control devices 60 (step 208). If so, the processing and storage unit 55 provides the stored content from the internal memory 56 to the display 52 (step 209). If a playback command has not been entered or, if entered, once the stored content has been provided to the display 52, the process returns (step 210) to the first step (step 200).

The digital set top box 51 is therefore capable of tuning into broadcast channels during the time interval during which those channels are broadcast to the geographical area in which the receiver 11, 12 is located, and to record the tuned content, if required, for later viewing.

In embodiments in which the set-top box 51 is capable of connecting to an external memory device 59, in the present example a USB flash memory device, the processing and storage unit 55 is arranged to store content in either or both of the internal and the external memory 56, 59 and to play back content stored at either of these devices 56, 59. The processing and storage unit 55 can also be arranged to transfer content stored in the internal memory 56 to the external memory 59 and vice versa, based on user commands received via the one or more user control devices 60. Accordingly, users are able to store content on an external memory device 59 using a first set top box 51 and to play back the content using another set top box or other device that can receive and access the external memory 59, for instance a computer.

The processing and storage unit 55 of the set top box 51 according to embodiments of the invention is also arranged to control the set top box 51 automatically enter a low power ‘sleep mode’ when not in use, for instance when the broadcast signal is not being transmitted to the area in which the receiver 11, 12 is located. The processing and storage unit 55 is arranged to automatically leave this mode and enter a transmission receiving mode during the time interval during which transmissions are made to the area in which the set-top box 51 is located. In one example, the processing and storage unit 55 is arranged to periodically switch on components of the set top box 51 to check the timing alignment of the clock 57 and to determine whether the broadcast signal is being transmitted to the geographical area in which the receiver 11, 12 is located. This enables power consumption of the receiver 11, 12 to be minimised when the broadcast signal is not transmitted and to automatically provide power to components of the set top box 51 when the signal is detected. For instance, the processing and storage unit 55 can be arranged to provide power to the digital tuner 53 and demodulation unit 54 for short periods at regular intervals, for instance for several milliseconds once every 5 to 10 seconds, so as to determine whether a DVB-SH signal is being received by the aerial 50. If so, the processing and storage unit 55 causes the set-top box 51 to ‘wake-up’ by automatically providing continual power such that broadcast content can be viewed and/or recorded.

The set top box 51 can also be arranged to synchronise its local clock 57 at regular intervals, for instance once every hour, with a clock synchronisation signal transmitted from the satellite 2.

The processing and storage unit 55 of the set top box 51 can also be arranged to receive information via the received downlink channel 10 indicating the broadcast schedule of the satellite transmissions 10a, 10b, in particular the time interval during which the broadcast signal will be transmitted to the geographical area in which the receiver 11, 12 is located. This information is generated at the respective one of the ground gateways 3, 5 which is being used to provide the uplink 4, 6 and is included within the multiplexes provided on the respective uplink 4, 6 to the satellite 2. The information is received, as part of the DVB-SH signal, at the antenna 50 and passed to the processing and storage unit 55 via the digital tuner 53 and demodulation unit 54.

The processing and storage unit 55 extracts the information and, based on the received information and on an output of the clock 57, is arranged to automatically enter a ‘sleep’ mode at times other than the time intervals when transmissions are made, such that broadcast content can be viewed and/or recorded. In this manner, only the processing and storage unit 55 and clock 57 require power at times other than the predetermined transmission interval. This reduces the overall power requirements of the set-top box 51 and, for instance, enables the set top box 51 to be powered by an internal battery (not shown) at times other than the time interval, for instance when in standby mode.

The broadcast content, which can, for instance, be television content or other forms of content such as audio content, is, in the present example, broadcast at the same rate as the content can be played-back, therefore resulting in a ‘linear’ broadcast arrangement whereby the content can be viewed as it is transmitted. However, broadcast arrangements involving non-linear broadcasts are also possible, for instance broadcasting at a rate greater than the rate at which the content is to be played back, such that the amount of broadcast content can be maximised, or at a rate slower than the rate at which the content is to be played back, such that the broadcast quality can be ensured. In embodiments in which non-linear transmissions are used, content is recorded in the internal memory 56 by default, and playback via the display 52 is performed from the memory 56 when requested by a user.

The input/output unit 58 of the set top box 51 can also be connected to a network such as the public switched telephone network (PSTN, not shown in figures). The connection of the set top box 51 to a network such as the PSTN, for instance, provides a mechanism for the set top box to communicate directly with the multiplex operators, thus enabling ‘on-demand’ content to be provided to the set top box 51 via the received broadcast transmission. The set top box 51 can further include a key-card (not shown) providing a user security key allowing the set top box 51 to decrypt decrypted content, such as on-demand content, received at the set top box 51. As an alternative or addition to a connection to the PSTN, a wireless connection such as a mobile-type GSM connection could be used or another connection suitable for providing communications between user receivers and content providers. In the case of GSM, separate GSM functionality, including a separate modulator, can for instance be provided at the user receiver either incorporated within the set top box 51 or provided in a separate unit.

The user receivers 11, 12, according to embodiments of the invention, can have polarisation functionality (not shown in Figures), to operate in conjunction with the polarisation capability of the satellite transmitter. A crossed Yagi antenna or multi-patch antennas can, for instance, be used as the receiver antenna 53. The receiver can be arranged to receive either or both polarisations. For instance, in the case of circular polarisation, the receiver can be arranged to pick up left hand polarised signals and to reject right hand signals (typically by 15 dB) or vice versa. A particular polarisation can, for instance, be used for a particular type of broadcast content or for content intended for a specific portion of the geographical area over which the broadcast signal is transmitted. The degree of isolation achieved at the receiver is adequate for QPSK modulation but higher order schemes, such as 16 QAM, may require a better signal to noise ratio. A polarisation switch (not shown) for selecting the required receive polarisation(s), could be arranged between the receive antenna 50 and the digital tuner 53.

Although specific embodiments of the invention have been described, the skilled person would realise that the invention is not limited to such embodiments and that alternative arrangements can be used.

For instance, although the satellite 2 has been described as comprising a parabolic reflector transmit antenna, other antenna arrangements are possible, such as a phased-array type antenna or a defocused antenna. Also, direction of the broadcast signal to a particular geographical area has been described as being implemented by adjusting beam-forming coefficients. However, alternative arrangements are possible, for instance a satellite broadcast directed by moving a steerable transmit antenna, or using multiple antennas, each pre-configured or steered to transmit to a particular geographical area.

The satellite is also not limited to providing the satellite broadcast to a single geographical area in any time interval, but can also be arranged to transmit to more than one geographical area simultaneously, for instance using multiple transmit antennas or a single antenna used to provide multiple spot beams over an area. The spot beams can be spatially separated such that common frequencies can be used between the spot beams without interference between the beams, having the advantage of increasing the efficiency of usage of the available frequency spectrum. Clearly, the total power consumption would need to be kept within the limits of the satellite.

In relation to the signal standards and modulation, although QPSK modulation has been described, where power flexibility permits then higher order modulation schemes may be used. For example, use of 16 QAM at rate ¾ coding provides a useful bit rate of 18.1 Mbit/s for each multiplex. The terrestrial equivalent of 64 QAM at ⅔ rate coding provides 24.13 Mbit/s but at the expense of requiring almost four times the power. The physical layer format is also not limited to DVB-SH.

Although a COFDM signal has been described, the invention is also not limited to this and alternative multiplexing schemes could be used.

The satellite has been described as including a control data receiving antenna, although this is not essential. Alternatively, control data updates could be provided as part of the uplink signals or omitted entirely, depending on the circumstances.

Although a single satellite 2 has been described, in further embodiments of the invention, the satellite 2 of FIG. 1 is one of two or more satellites co-located at the same orbit location. A first of the satellites is the prime, carrying the multiplexes, and the second and any further satellites are spares, switched off until they may be required in the event of a failure in the first. Alternatively, the spare satellite(s) could be switched on to act as ‘hot’ standbys with their power amplifiers muted so that they could take over from the prime satellite very quickly.

Furthermore, although first and second ground gateways 3, 5 are described, only a single ground gateway could be used, or three or more could be used, as required by the circumstances. For instance, in the case of a satellite system providing services to more than one country, it is possible for arrangements of multiple ground gateways to be replicated per country, where each arrangement would operate independently, for instance providing specific content to be broadcast to users in that country.

Also, although the broadcast signal is up-converted to and transmitted at UHF Band V, namely spanning channels 52 to 68 in the UHF terrestrial broadcasting plan, other broadcasting frequencies can be used. In particular, the invention can have significant advantages when operating over other broadcast frequency ranges such as ranges between 2.5 GHz and 40 GHz, for instance the Ku and Ka ranges. For instance, the use of broadcasts time-divided between geographical locations enables different content to be transmitted to neighbouring geographical regions whilst avoiding any interference issues between the signals which would occur with continuous broadcasts to the regions. Peak power requirements at the satellite are also reduced by the non-continual illumination of the broadcast regions. Also, by providing coverage to individual regions rather than on a larger scale, content can be selected and broadcast on a region-by-region basis, where the region can, for instance, be all or part of an individual country. This enables broadcasting issues such as digital rights management to be resolved on a region-by-region basis, improving the flexibility of the broadcast system from the perspective of content providers.

The broadcast signal can also be provided in other frequency ranges and/or at power levels which allow relatively low-cost antennas such as Yagi-Uda antennas to be used at the receivers 11, 12, for instance frequencies anywhere within the UHF frequency band or lower portions of the SHF frequency band, in particular between 600 MHz and 2.5 GHz.

A set top box 51 having a single tuner has been described, although the invention is not limited to this. Alternative set top boxes according to the invention can include multiple tuners, enabling once broadcast programme channel to be viewed on a display while another channel is recorded in the internal and/or external memory.

Although the receivers 11, 12 have been described as set top box arrangements, the invention is not limited to this. Advantageously, the present invention can also be used to provide content such as video to mobile handsets within the geographical areas, as a result of the relatively high power levels provided to each geographical area. This is particularly straightforward in embodiments in which the satellite broadcast signal is provided in the DVB-SH format.

The invention can be applied to multiple types of content and is not limited to audio and video content or to television content. Other data can be broadcast and can, for instance, be arranged according to the DVB-SH format for reception by the receivers 11, 12.

1. A content broadcasting system, comprising:
a communications satellite; and
a satellite control arrangement for controlling the communications satellite to transmit a satellite broadcast signal, wherein the satellite control arrangement is arranged to control the satellite according to a predetermined broadcast schedule so as to:
transmit said satellite broadcast signal to a first geographical area during a plurality of first time intervals such that it can be received by receiving devices in the first geographical area during the first time intervals; and
transmit said satellite broadcast signal to a second geographical area during a plurality of second time intervals such that it can be received by receiving devices in the second geographical area during the second time intervals, wherein said broadcast signal is not transmitted to the first geographical area during at least said second time intervals and said broadcast signal is not transmitted to the second geographical area during at least said first time intervals.

2. A content broadcasting system according to claim 1, wherein the satellite control arrangement is arranged to control the satellite to transmit the satellite broadcast signal at the same frequency during the pluralities of first and second time intervals.

3. A content broadcasting system according to claim 1, wherein the satellite broadcast signal is used to broadcast first content during said first time intervals and to broadcast second content, different from said first content, during said second time intervals.

4. A content broadcasting system according to claim 1, comprising:
a first receiving device located within the first geographical area; and
a second receiving device located within the second geographical area, wherein, the first receiving device is arranged to receive the satellite broadcast signal during the first time intervals and the second receiving device is arranged to receive the satellite broadcast signal during the second time intervals, wherein the first receiving device is arranged to record content associated with the satellite broadcast signal transmitted during the first time intervals and wherein the second receiving device is arranged to record content associated with the satellite broadcast signal transmitted during the second time intervals.

5. A content broadcasting system according to claim 4, wherein the first receiving device comprises:
a connector for connecting to a removable storage medium and is arranged to record content associated with the satellite broadcast signal on a removable storage medium coupled to the connector.

6. A content broadcasting system according to claim 4, wherein the first receiving device comprises:
a processor configuration arranged to control the first receiving device to enter a power-saving mode at times other than the first time intervals.

7. A content broadcasting system according to claim 6, wherein the processor configuration is arranged to detect the transmission of the broadcast signal to the at least one first geographical area and to control the first receiving device to stop using the power saving mode in response to the result of the detection.

8. A content broadcasting system according to claim 6, wherein the first receiving device comprises:
a clock, wherein the satellite broadcast signal comprises information indicating at least one of said first time intervals, and wherein the processor configuration is arranged to control the first receiving device to enter a sleep mode at times other than the at least one of the first time intervals, in accordance with the information and an output from the clock.

9. A content broadcasting system according to claim 1, wherein the satellite control arrangement is arranged to control the satellite to direct said satellite broadcast signal to one or more further geographical areas during one or more respective pluralities of further time intervals.

10. A content broadcasting system according to claim 9, wherein the pluralities of first, second and one or more further time intervals comprise:
a sequence of time intervals, and wherein the sequence is repeated.

11. A content broadcasting system according to claim 1, wherein the satellite broadcast signal is used to broadcast an audio and/or video signal at a data rate slower or faster than a data rate of the audio and/or video signal when reproduced.

12. A content broadcasting system according to claim 1, wherein the satellite broadcast signal is transmitted at frequencies between and including 600 MHz to 40 GHz.

13. A content broadcasting system according to claim 1, wherein the satellite broadcast signal is transmitted at frequencies in the UHF or SHF frequency range.

14. A content broadcasting system according to claim 1, wherein the satellite broadcast signal is transmitted at frequencies between and including 600 MHz to 2.5 GHz.

15. A content broadcasting system according to claim 1, wherein the satellite broadcast signal is receivable using a Yagi-Uda antenna.

16. A content broadcasting system according to claim 1, wherein the satellite control arrangement is arranged to control the satellite so as to:
transmit said satellite broadcast signal to a plurality of first geographical areas, including the first geographical area, during the first time intervals such that it can be received by receiving devices any of the plurality of first geographical areas during the first time intervals; and
transmit said satellite broadcast signal to a plurality of second geographical areas, including the second geographical area, during the second time intervals such that it can be received by receiving devices in any of the plurality of second geographical areas during the second time intervals.

17. A content broadcasting system according to claim 16, wherein the broadcast signal is used to provide content to a first one of the plurality of first geographical areas which is different from content provided to a second one of the plurality of first geographical areas.

18. A method of broadcasting content, the method comprising:
transmitting a satellite broadcast signal according to a predetermined broadcast schedule, wherein the satellite broadcast signal is transmitted:
to a first geographical area during a plurality of first time intervals such that it can be received by receiving devices in the first geographical area during the first time intervals; and
to a second geographical area during a plurality of second time intervals such that it can be received by receiving devices in the second geographical area during the second time intervals, wherein said broadcast signal is not transmitted to the first geographical area during at least said second time intervals and said broadcast signal is not transmitted to the second geographical area during at least said first time intervals.

19. A method according to claim 18, wherein the pluralities of first and second time intervals comprise:
a repeating sequence of time intervals according to the broadcast schedule.

20. A method according to claim 18, wherein the satellite broadcast signal is used to broadcast an audio and/or video signal at a data rate slower or faster than a data rate of the audio and/or video signal when reproduced.
